(19) United States
(12) Patent Application Publication
(10) Pub. No.: US 2026/0001504 A1
(43) Pub. Date: Jan. 1, 2026

(54) SUPPORT BRACKET FOR A FRONT VEHICLE FASCIA

(71) Applicant: FCA US LLC, Auburn Hills, MI (US)

(72) Inventors: Zhenghong Yan, Shanghai (CN); Ziye Wang, Shanghai (CN); Dan Li, Shanghai (CN); Wenbin Song, Shanghai (CN); Bing Li, Shanghai (CN)

(21) Appl. No.: 18/758,226

(22) Filed: Jun. 28, 2024

(51) Int. Cl. B60R 19/18

(52) U.S. Cl. CPC B60R 19/18; B60R 2019/1886

(57) ABSTRACT

A support bracket for a vehicle bumper nose fascia has a base plate with an overall quadrilateral configuration with a curve portion on opposing sides. A cube member projects from the base plate. The cube dividing the base plate into two halves. The two halves each include a bore to receive a securement fastener. The cube is adjacent an edge of the base plate. A support portion is adjacent another edge of the base plate. It has a securement bore. A window is in one of the cube sides to enable sensor access through the cube.

The present application is related in general subject matter to pending U.S. patent application Ser. No. ______ (Attorney Docket No. 712340US1), filed concurrently herewith, entitled “Front Bumper Assembly,” assigned to FCA US LLC, and hereby incorporated by reference in its entirety into the present application. The present application is further related in general subject matter to pending commonly assigned U.S. patent application Ser. No. ______ (Attorney Docket No. 712341US1), filed concurrently herewith, entitled “Vehicle Bumper Cover Or Soft Nose Fascia,” hereby incorporated by reference in its entirety into the present application.

### FIELD

The present disclosure relates to automotive vehicles and, more particularly, to a support bracket for a front vehicle fascia.

### BACKGROUND

This section provides background information related to the present disclosure which is not necessarily prior art.

The front bumper nose fascia is generally received onto the vehicle framework. The bumper nose fascia generally is plastic and over a period of time is subjected to sag over the time period. The sag leads to undesirable appearance. Thus, it would be desirable to have a front bumper nose fascia that is supported against sag to provide a pleasing aesthetic appearance. Accordingly, the present disclosure provides such support.

### SUMMARY

This section provides a general summary of the disclosure, and is not a comprehensive disclosure of its full scope or all of its features.

The present disclosure provides a support bracket to eliminate sag in front bumper nose fascia of a vehicle. The present disclosure provides a bracket to support sensor positioning.

According to a first aspect of the disclosure, a bracket for supporting a front vehicle fascia comprises a base plate with an overall quadrilateral configuration with curved portions on opposing sides. A cube member projects from the base plate. The cube member divides the base plate into two halves. Each half includes a bore to receive a securement fastener. The cube member is adjacent to an edge of the base and to a support portion on the other edge of base plate. The support portion includes a securement bore. A window is in one of the side members of the cube to enable access through the cube to a sensor. The cube side members are trapezoidal and wider at the base plate. The truncated end of the cube has an overall rectangular configuration. The cube side member opposing the window includes a spacer to rest against a bumper. The sidewall opposite the window is arcuate.

According to a second aspect of the disclosure, a vehicle comprises a bumper and a front nose fascia secured to the bumper. A bracket is secured to the bumper to support the fascia. The bracket has an overall quadrilateral configuration with curved portions on opposing sides. A cube member projects from the base plate. The cube member divides the base plate into two halves. Each half includes a bore to receive a securement fastener. The cube member is adjacent to an edge of the base and to a support portion on the other edge of base plate. The support portion includes a securement bore. A window is in one of the side members of the cube to enable access through the cube to a sensor. The cube side members are trapezoidal and wider at the base plate. The truncated end of the cube has an overall rectangular configuration. The side cube member opposing the window include a spacer to rest against a bumper. The sidewall opposite the window is arcuate.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of a fascia assembly.

FIG. 2 is a perspective view of a support bracket.

FIG. 3 is a perspective view of the bracket on a bumper.

FIG. 4 is a cross-section view of FIG. 3.

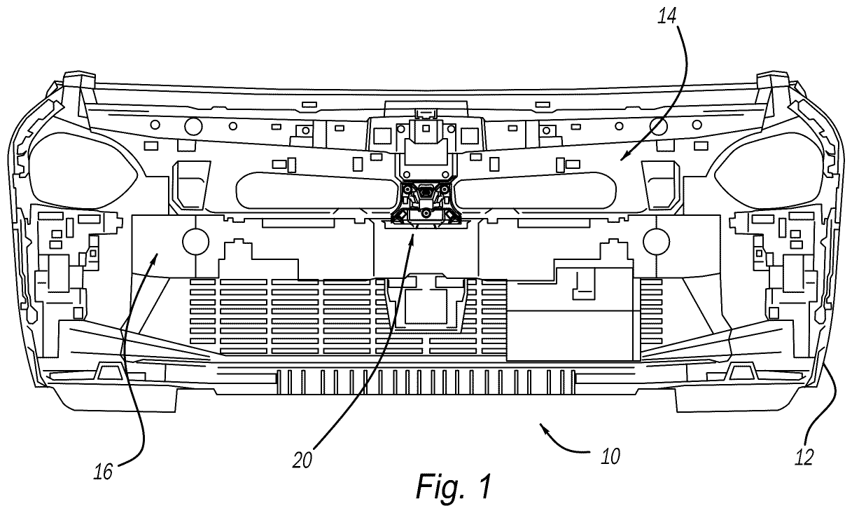

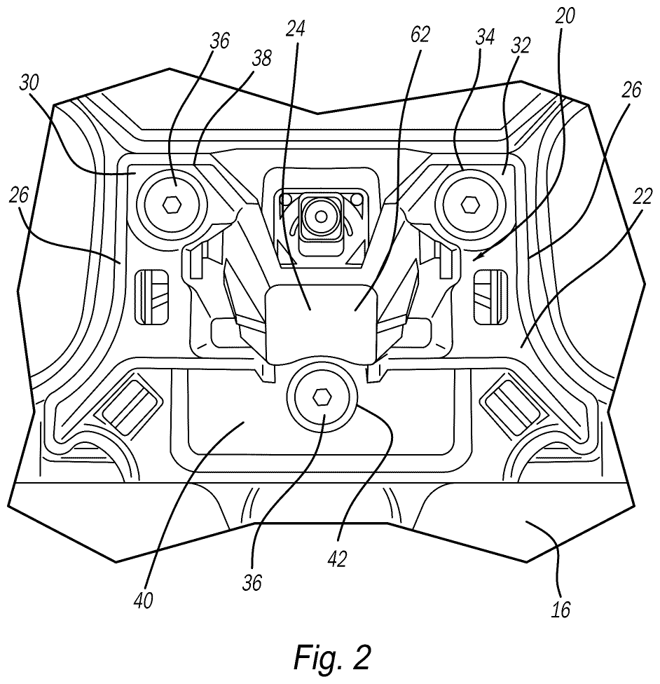

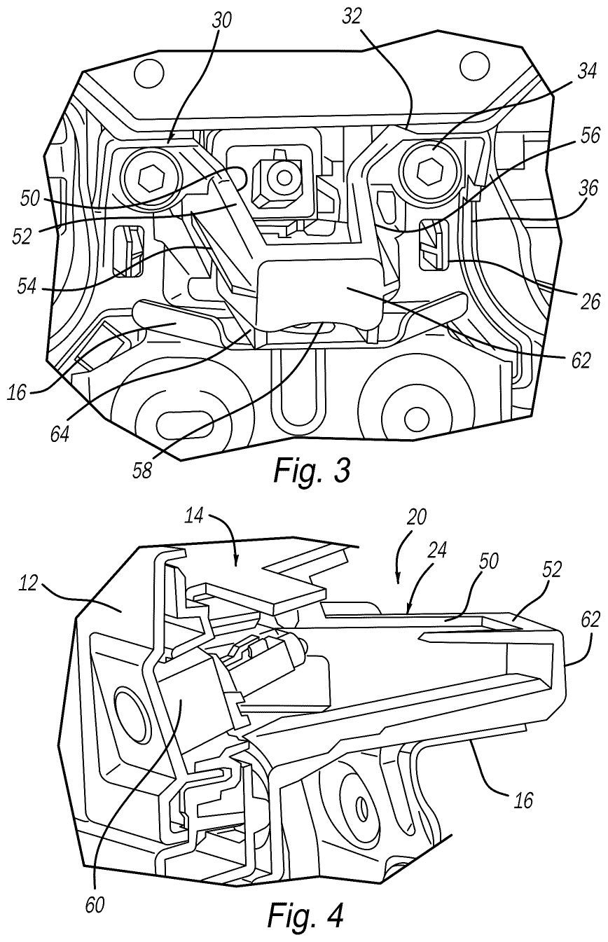

Corresponding reference numerals indicate corresponding parts throughout the several views of the drawings.

### DETAILED DESCRIPTION

Example embodiments will now be described more fully with reference to the accompanying drawings.

Turning to the figures, a fascia assembly is illustrated and designated with the reference numeral 10. The assembly includes a fascia cover 12, a reinforcement member 14, a bumper 16 and a support bracket 20.

The bracket 20 includes a base plate 22 and a cube member 24. The base plate 22 has an overall quadrilateral configuration with curved side portions 26 on opposing sides of the plate 22. The cube member 24 projects from the base plate 22 dividing the base plate 22 into two halves 30, 32. The halves 30, 32 are mirror images of one another and each include a bore 34 to receive a securing fastener 36. The cube 24 is adjacent a top edge 38 of the base plate 22. A support portion 40 of the base plate 22 is below the cube 24. The support portion 40, acting as a web, connects the two halves 32, 34 together. The support portion 40 includes an aperture 42 with a fastener 36 to secure the bracket to the reinforcement 14.

The cube member 24 includes a window 50 on one of the cube sides 52. The window 50 enables a sensor 60 to be protected by the support and function in its normal capacity. The sensor 60 may be a camera or the like that provides information to the occupant. The cube sides 52, 54, 56 have an overall trapezoidal configuration that are wider at the base plate 22. The sides 52, 54, 55 terminate at a truncated end 62 that has an overall rectangular configuration. The side 58 that opposes the window 50 includes at least one spacer 64, two shown, resting upon the bumper 16. The spacer provides a desired height of the bracket 20 from the bumper 16 to ensure a proper spacing between a hood and the nose fascia 12. The side 58 is arcuate between the spacers 64. Thus, the bracket 20 with its cube member 24 provides a support for the bumper fascia 12 as well as a casing or housing for the sensor 60.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A bracket for supporting a vehicle bumper nose fascia comprising:
a base plate having an overall quadrilateral configuration with a curve portion on opposing sides;
a cube projecting from the base plate, the cube dividing the base plate into two halves, the two halves each including a bore for receiving a securement fastener;
the cube adjacent an edge of the base;
a support portion on another edge of the base plate including a securement bore; and
a window in one of the cube sides for enabling sensor access through the cube.

2. The bracket of claim 1, wherein the cube sides are trapezoidal being wider at the base plate.

3. The bracket of claim 1, wherein the truncated end of the cube has an overall rectangular configuration.

4. The bracket of claim 3, wherein the cube side opposing the window includes a spacer for resting against a bumper.

5. The bracket of claim 1, wherein the sidewall opposite the window is arcuate.

6. A front end of a vehicle comprising:
a bumper and a nose fascia secured to the bumpers;
a bracket secured to the bumper for supporting the nose fascia;
the bracket includes
a base plate having an overall quadrilateral configuration with a curve portion on opposing sides;
a cube projecting from the base plate, the cube member dividing the base plate into two halves, the two halves each including a bore for receiving a securement fastener;
the cube adjacent an edge of the base;
a support portion on another edge of the base plate including a securement bore; and
a window in one of the cube sides for enabling sensor access through the cube.

7. The front end of a vehicle of claim 1, wherein the cube sides are trapezoidal being wider at the base plate.

8. The front end of a vehicle of claim 1, wherein the truncated end of the cube has an overall rectangular configuration.

9. The front end of a vehicle of claim 8, wherein the cube side opposing the window includes a spacer for resting against a bumper.

10. The bracket of claim 1, wherein the sidewall opposite the window is front end of a vehicle arcuate.
